(19) United States
(12) Patent Application Publication
(10) Pub. No.: US 2026/0048685 A1
(43) Pub. Date: Feb. 19, 2026

(54) METHOD AND SYSTEM FOR CONTROLLING A FUEL CELL ELECTRIC VEHICLE UNDER A POWER CONSERVATION MODE

(71) Applicant: Ford Global Technologies, LLC, Dearborn, MI (US)

(72) Inventors: Zeng QIU, Ann Arbor, MI (US); Valentina MEJIA MEJIA, Royal Oak, MI (US); Hao WANG, Ann Arbor, MI (US); Kevin Ray RUYBAL, Canton, MI (US); William Frederick SANDERSON, Jr., Commerce Twp., MI (US); Michiel J. VAN NIEUWSTADT, Ann Arbor, MI (US)

(21) Appl. No.: 18/804,945

(22) Filed: Aug. 14, 2024

(51) Int. Cl. B60L 58/30; B60L 58/12; H01M 8/0432; H01M 8/0444; H01M 8/04492; H01M 8/04746; H01M 8/04791; H01M 8/04858; H01M 8/04992

(52) U.S. Cl. CPC B60L 58/30; B60L 58/12; H01M 8/04358; H01M 8/04455; H01M 8/04492; H01M 8/04753; H01M 8/04805; H01M 8/0488; H01M 8/0494; H01M 8/04992; H01M 2250/20

(57) ABSTRACT

During some operations, a fuel cell system of a FCEV is operated in a voltage suppression mode when the FCEV is in park and power demand is low to reduce wear of the fuel cell system. However, in the voltage suppression mode, liquid water may accumulate in the fuel cell system, because of low flow of reactant gases which typically remove the water. If the FCEV exits the park state and undergoes a high acceleration, the water can inhibit reactant flow.

### STATEMENT REGARDING FEDERALLY SPONSORED RESEARCH OR DEVELOPMENT

This invention was made with Government support under Contract No. DE-EE0009858 awarded by the U.S. Department of Energy. The Government has certain rights in the invention.

### TECHNICAL FIELD

The present disclosure generally relates to a system or method for controlling power generated by a fuel cell system of a fuel cell electric vehicle (FCEV).

### BACKGROUND

A FCEV includes one or more fuel cell stacks that provide electrical power for propelling the FCEV. The fuel cell stack is an electrochemical device that converts chemical energy of hydrogen fuel and an oxidizing agent into electrical energy, with water as a byproduct. In some applications, the FCEV may further include a high voltage battery pack to provide electrical power to propel the FCEV separately or in combination with the fuel cell stacks.

At times when the FCEV is parked and idle, the FCEV can operate in a voltage suppression control to inhibit or curb the electrochemical reaction and constrain degradation of the fuel cell stack.

### SUMMARY

In one form, the present disclosure is directed a method for controlling a fuel cell electric vehicle (FCEV) having a fuel cell system. The method includes restricting, for a power conservation mode, electric current draw of a fuel cell stack of the fuel cell system, and performing, for the power conservation mode, at least one of selectively supplying air to the fuel cell system to control a voltage of the fuel cell system, or selectively supplying air to an exhaust flow line to dilute concentration of fluid flowing therein.

In one form, the present disclosure is directed to a control system for a fuel cell electric vehicle (FCEV) having a fuel cell system. The control system includes a processor and a non-transitory computer-readable storage medium comprising programming instructions that are configured to cause the processor to implement a method for controlling the FCEV. The programming instructions comprise instructions to restrict, for a power conservation mode of the fuel cell system, electric current draw from a fuel cell stack of the fuel cell system, and perform, for the power conservation mode, at least one of selectively supply air to the fuel cell system to control a voltage of the fuel cell system, or selectively supply air to an exhaust flow line of the FCEV to dilute concentration of fluid flowing therein.

### BRIEF DESCRIPTION OF THE DRAWINGS

FIG. 1 illustrates an example fuel cell electric vehicle (FCEV);

FIG. 2 is an example block diagram of a fuel cell system for the FCEV;

FIG. 3 is an example block diagram of a stack-cell voltage suppression control; and

FIG. 4 is a flowchart of an example power conservation routine for the FCEV.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

During some operations, a fuel cell system of a FCEV is operated in a voltage suppression mode when the FCEV is in park and power demand is low to reduce wear of the fuel cell system. However, in the voltage suppression mode, liquid water may accumulate in the fuel cell system, because of low flow of reactant gases which typically remove the water. If the FCEV exits the park state and undergoes a high acceleration, the water can inhibit reactant flow, which can result in poor performance or shutdown of the fuel cell system.

In one form, the present disclosure is directed to a method/system for controlling the FCEV in the voltage suppression mode or a power conservation mode to not only address the accumulation of water in the fuel cell system, but also address other potential challenges such as but not limited to, low voltage of the fuel cell system and exhaust H2 concentration level. In a non-limiting example, the system of the present disclosure is configured to selectively supply reactants (e.g., air) to the fuel cell system to control a voltage of the fuel cell system and/or selectively supply reactants (e.g., air) to an exhaust flow line of the FCEV to dilute H2 concentration of fluid flowing therein. With additional control techniques described herein for the power conservation mode, the system of the present disclosure may mitigate issues related to operating the FCEV in a low power operation.

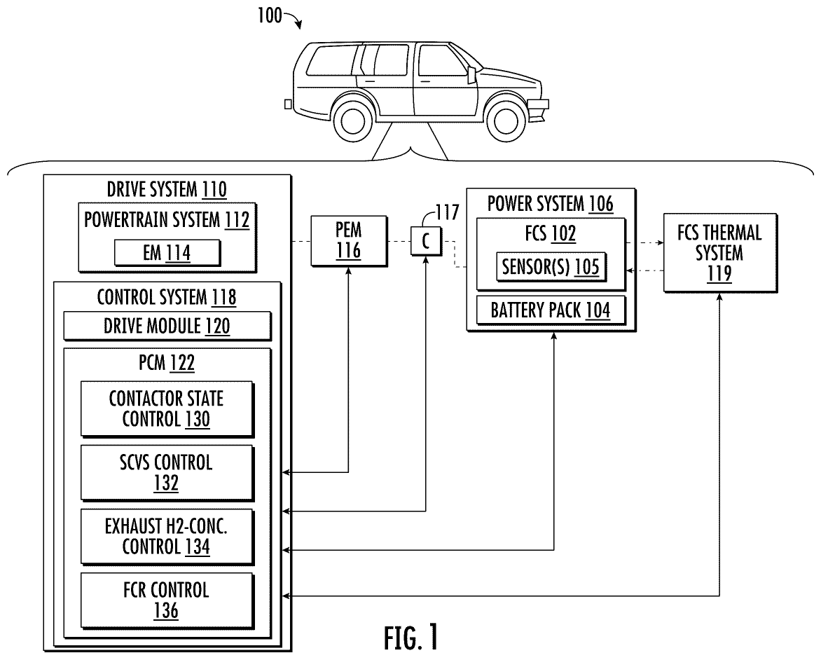

Referring to FIG. 1, an example fuel cell electric vehicle (FCEV) 100 includes a fuel cell system (FCS) 102 and a battery pack 104 (e.g., a traction battery) that form at least a portion of a power system 106 of the FCEV 100. The FCS 102 and the battery pack 104 are individually operable for providing electrical energy for propulsion of the FCEV 100 via a drive system 110. In FIG. 1, dashed lines represent power lines for high electric power and solid lines indicate control signals or data communication.

In one form, among other components, the drive system 110 includes a powertrain system 112 having one or more electric machines (EM) 114 capable of operating as a motor and as a generator. As a motor, the EM 114, which is mechanically connected to a transmission (not shown), provides propulsion and slowing capability for the FCEV 100. The EM 114 acting as a generator may recover energy that may normally be lost as heat in a friction braking system (not shown) to recharge the battery pack 104.

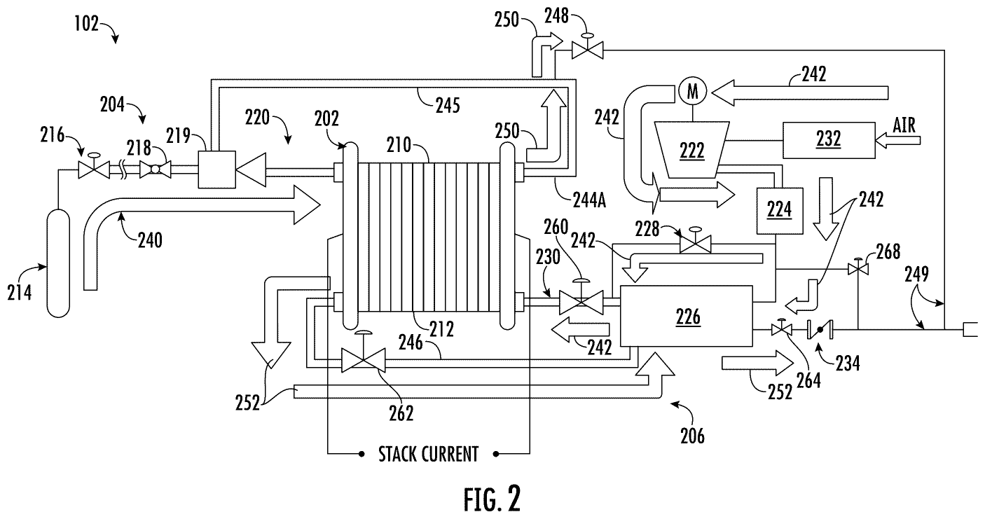

The FCS 102 includes one or more fuel cell stacks, where the fuel cell stack includes a plurality of fuel cells electrically connected in series. As described further below with reference to FIG. 2, the FCS 102 converts hydrogen fuel into electrical energy that is used by the EM 114 for propelling the FCEV 100 and/or for recharging the battery pack 104. In one form, the FCS 102 includes one or more sensors 105 configured to detect different operation characteristics of the FCS 102, such as but not limited, detecting voltage, electric current, H2 concentration in exhaust byproduct, pressure, and/or temperature.

The FCS 102 and the battery pack 104 may be electrically connected to the EM 114 via a power electronics module (PEM) 116 that may include an inverter, direct current (DC)-to-DC converter, among other components. In one form, the PEM 116 is configured to transfer electrical energy from the FCS 102 to the EM 114. For example, the FCS 102 may provide DC electrical energy while the EM 114 may require three-phase alternating current (AC) electrical energy to function. The PEM 116 may convert the electrical energy from the FCS 102 into electrical energy having a form compatible for operating the EM 114 or, in some applications, for charging the battery pack 104. In this way, the FCEV 100 may be configured to be propelled with use of electrical energy from the FCS 102.

The battery pack 104 stores electrical energy for use by the EM 114 for propelling the FCEV 100. The battery pack 104 may also be electrically connected to the EM 114 via the PEM 116. The PEM 116 may provide the ability to bi-directionally transfer electrical energy between the battery pack 104 and the EM 114. In this way, the FCEV 100 may be further configured to be propelled with the use of the battery pack 104 individually or in combination with the FCS 102. Furthermore, in a regenerative mode, the PEM 116 may convert AC electrical energy from the EM 114, acting as a generator, to DC electrical energy compatible with the battery pack 104.

In one form, the power system 106 is connected to the drive system and the PEM 116 via a contactor 117 to electrically connect and disconnect the power system 106 from other vehicle components. While one contactor 117 is illustrated, one or more contactors may be used. In addition, the contactor 117 may be arranged in other suitable positions, such as, but not limited to being integrated with the PEM 116.

Referring to FIG. 2, an example FCS 102 includes a fuel cell stack 202, a hydrogen supply-return system (hydrogen SRS) 204 for supplying hydrogen fuel to an anode side 210 of the fuel cell stack 202, and an air supply-return system (air SRS) 206 for supply air to a cathode side 212 of the fuel cell stack 202. The fuel cell stack 202 includes multiple fuel cells arranged in series and having anode members to define the anode side 210 and cathode members to define the cathode side 212. While one fuel cell stack 202 is illustrated, for simplicity, the FCS 102 may include more than one fuel cell stack 202.

In one form, the hydrogen SRS 204 includes a hydrogen tank 214 for storing the hydrogen fuel, a fuel control valve 216 (e.g., hydrogen pressure control valve) operable to control flow of fuel from the tank 214, and an injector valve 218 operable to supply the fuel to the fuel cell stack 202. In some applications, an anode supply manifold 220 supplies the fuel from the injector valve 218 to the fuel cell stack 202. It should be readily understood that the hydrogen SRS 204 may include additional components, such as but not limited to sensor devices, as part of sensors 105, arranged at the tank 214 and along a fuel line fluidly coupling the tank 214 and the fuel cell stack 202 to measure fuel characteristics (e.g., fuel characteristics include temperature and/or pressure). In one form, the hydrogen SRS 204 may also include conduit and other components along with those components described herein for defining a fuel flow line from, at least, the tank 214 to the fuel cell stack and to the exhaust line 249.

In one form, the air SRS 206 includes a compressor 222 for drawing and supplying air to the fuel stack 202 by way of an intercooler 224 to cool the air from the compressor 222. In some aspects, a humidifier 226 is provided to condition air provided to the fuel cell stack 202 and air being returned from fuel cell stack 202. A bypass valve 228 may be provided to bypass the humidifier 226 such that air from the intercooler 224 flows to the fuel cell stack 202. In other variations, a cathode supply manifold 230 supplies air to the cathode side 212 of the fuel cell stack 202. The air SRS 206 may include other components such as, but not limited to, an air filter 232 upstream of the compressor 222 and one or more sensor devices, as part of sensors 105, arranged between an inlet drawing air into the air SRS 206 and the cathode supply manifold 230 (e.g., temperature sensor and/or pressure sensor). In one form, the air SRS 204 may also include conduit and other components along with those components described herein for defining an air-cathode flow line from, at least, an inlet drawing in air to the compressor to the fuel cell stack and to the exhaust line 249.

In operation, hydrogen is injected into the anode side 210 and air is pushed to the cathode side 212. On the anode side 210 hydrogen molecules split into electrons and protons. The protons pass through an electrolyte section and the electrons flow through a circuit generating an electric current and heat. At the cathode side 212, the protons, electrons, and oxygen combine forming water byproduct. Arrow 240 provides an example flow of fuel to the fuel cell stack 202 along the hydrogen SRS 204 and arrows 242 provide an example flow of air to the fuel cell stack 202 along the air SRS 206.

From the fuel cell stack 202, the by product from the anode side 210 is directed out of the fuel cell stack 202 to an exhaust line 249 via a return manifold 244 and a purge valve 248. Some of the byproduct from the anode side 210 is directed towards the anode supply manifold 220, via a recirculation line 245. The recirculation may be driven by a recirculation blower (not shown) or by an ejector 219. In addition to the byproduct, the return manifold 244 is further configured to remove residual gases and water provided at the return manifold 244. The flow of byproduct/extra hydrogen along the hydrogen SRS 204 to the exhaust is illustrated by arrow 250.

From the fuel cell stack 202, the byproduct from the cathode side 212 is directed to the exhaust line 249 via a return manifold 246. In addition to the return manifold 246, the air SRS 206 may also include an electronic throttle body 234. The flow of the byproduct/air of the air SRS 206 is illustrated by arrows 252.

As noted above, the fuel cell stack 202 includes a series connection of fuel cells. The voltage of each fuel cell may depend on various factors including, but not limited to, cell temperature, membrane humidity, pressure, anode hydrogen amount, air flow rate, and/or electric current generated. In a non-limiting example, the voltage of the fuel cell stack 202 may be a summation of all the voltages of the fuel cells. Likewise, each fuel cell may have the same current, and the electric current of the fuel cell stack 202 may be inferred as the same as the current of each fuel cell. Accordingly, the power provided by the fuel cell stack 202 may be equal to the voltage of fuel cell stack 202 multiplied by the current of the fuel cell stack 202.

With continuing reference to FIG. 1, to control the temperature of the FCS 102, the FCEV 100 further includes a FCS thermal system 119 configured to control the temperature of the FCS 102. In a non-limiting example, a coolant may be provided to and circulated around the fuel cell stack 202 and other components to absorb heat from the components and is returned to the thermal system 119. In one form, the FCS thermal system 119 may include sensors (not shown) for measuring characteristics of the coolant (e.g., temperature, pressure) of the coolant entering and leaving the FCS 102, which may be used to control the FCS 102 as described further below. In FIG. 1, the dashed-dot-line illustrates coolant fluid lines.

In one form, the drive system 110 includes a control system 118 having one or more controllers to control and monitor the operation of the FCS 102 and the battery pack 104. In a non-limiting example, the control system 118 is configured to include a drive module 120 and a power conservation module (PCM) 122.

In one form, the drive module 120 to determine a drive demand based on, for example, state of charge (SOC) of the battery pack 104, voltage and current of the FCS 102, position of a brake pedal and/or a position of an acceleration pedal. Using stored algorithms, the drive module 120 determines the amount of power needed to meet a drive demand (e.g., a power request) and controls the FCS 102 and/or the battery pack 104 to generate the required power. In a non-limiting example, the control system 118 draws power from the FCS 102, the battery pack 104, or both the FCS 102 and the battery pack 104.

In one form, the drive module 120 is configured to detect a power conservation mode, which is also be referred to as a voltage suppression mode, to have the PCM 122 control the FCS 102 to generate little to no power. That is, at times, the FCEV 100 may not require high power to, for example, move the FCEV 100, and therefore, to limit wasteful fuel usage and/or degradation of the fuel cells, a power conservation mode may be employed. In a non-limiting example, the drive module 120 detects the power conservation mode when the FCEV 100 is in the park state or an idle state with a low load demand of the FCEV 100 for a selected time period (e.g., 10 seconds), which may occur when the FCEV 100 is at stop light or sitting idle in traffic. In another example, the drive module 120 detects the power conservation mode when the SOC of the battery pack 104 is greater than or equal to an upper SOC threshold (e.g., 85% or 90%). That is, power from the FCS 102 may be used to charge the battery pack 104, and if the SOC is high then the battery pack 104 could reach or exceed a manufacturing limit potentially reducing a battery life if the battery pack 104.

Once in the power conservation mode, the PCM 122 is configured to limit/restrict power output by the fuel cell stack 202. In a non-limiting example, the PCM 122 controls flow of reactant (e.g., fuel and/or air) to the fuel cell stack 202 to control a voltage of the FCS 102 to a stack voltage threshold and/or restrict current drawn from the fuel cell stack 202. The PCM 122 is further configured to selectively supply air to an exhaust line diluting concentration of fluid flowing through (e.g., diluting H2 concentration). In one form, the PCM 122 is configured to have a contactor state control 130, stack-cell voltage suppression (SCVS) control 132, an exhaust H2 concentration (H2-conc) control 134, and a fuel cell refresh (FCR) control 136.

The contactor state control 130 is configured to maintain the contactor 117 in a closed position for electrically coupling the power system 106 to the load including the drive system 110. With the contactor 117 being in the closed state, power may be drawn from the power system 106 once the power conservation mode is exited without delay. In a non-limiting example, the control system 118 is configured to detect when the FCEV 100 is to be turned ON or OFF based on an activation input (e.g., a user pressing a button associated with activating/deactivating the FCEV 100). If the FCEV 100 is to be turned ON, the control system 118 closes the contactor 117 via a power switch driver (not shown) electrically coupling the power system 106 to the PEM 116. If the FCEV 100 is to be turned OFF, the control system 118 opens the contactor 117 via the power switch driver, thereby electrically decoupling the power system 106 from the PEM 116. In one form, once opened/closed, the contactor 117 remains open/close until driven by the power switch driver again. Accordingly, during the power conservation mode, the contactor state control 130 detects the state of the contactor 117 using, for example, data from the contactor 117 that provides data indicative of the state of the contactor 117. If the contactor 117 is closed, the contactor state control 130 closes the contactor 117 via the power switch driver.

The SCVS control 132 is configured to control the voltage of the fuel cell stack 202 or at least a set of cells among the plurality of cells of the fuel cell stack 202 such that the voltage is provided at or between an upper and lower voltage range/threshold (e.g., FCS voltage threshold). In the following, “cell voltage” (VCELL) refers to voltage of individual cells and “stack voltage” (VSTACK) is the voltage of the fuel cell stack 202. While the overall power provided by the fuel cell stack 202 is low through, for example, limited/no supply of air stoic, the stack voltage is to be at or above a stack voltage threshold (e.g., above or at a DCDC limit). The SCVS control 132 suppresses or minimizes a max cell voltage by drawing a small amount of electric current and maintaining a stack voltage by supplying air to the fuel cell stack 202.

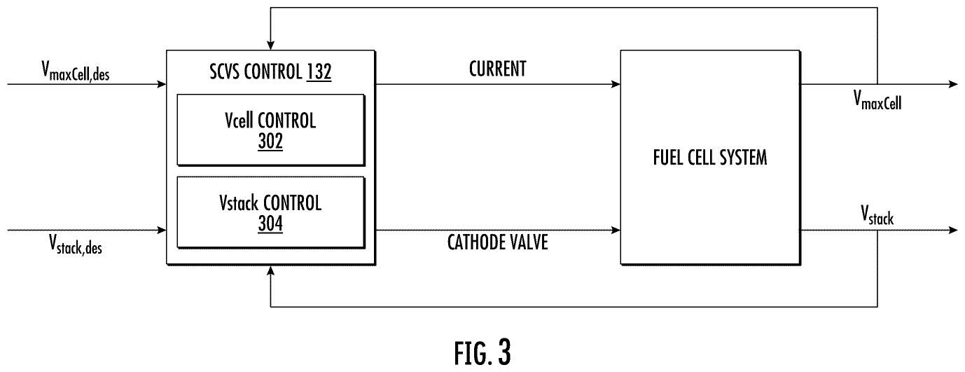

More particularly, in one form, the SCVS control 132 is configured to (1) control electric current of the fuel cell stack 202 to control a max cell voltage to be less than or equal to cell voltage threshold (e.g., V_{maxCell,des}) which is set at, for example, 0.85V, and (2) manage air through the cathode side of the fuel cell stack 202 to control the stack voltage to the stack voltage threshold (e.g., V_{stack,des}) with the compressor 222 kept at a constant speed. Referring to FIG. 3, the SCVS control 132 may be visualized as two control loops including a Vcell control 302 and a Vstack control 304 that are correlated for controlling voltage of the FCS 102, but distinct to provide two different control options.

With continuing reference to FIG. 2, to control the air through the fuel cell stack 202, the SCVS control 132 is configured to control a cathode throttle using at least one of a cathode inlet valve (CBV inlet) (e.g., valve 260), the cathode outlet valve (CBV outlet) (e.g., valve 262), or humidifier outlet valve (HOV) (e.g., valve 264) (collectively “cathode valves 260, 262, 264”). For example, the SCVS control 132 is configured to adjust opening of one of the cathode valves 260, 262, 264 while the other two cathode valves are held constant at larger openings. In one form, the SCVS control 132 employs Algorithm 1 to determine the amount of current to be drawn and Algorithm 2 to determine valve opening (θᵥₐₗᵥₑ, which is a valve between 0-100%), where “Iₙₒₘ” is a nominal current feed forward, which is a function of maximum stack power (Pmax) and stack voltage (Vstack), “kp1” and “kp2” are positive constant gains. Iₙₒₘ may be small enough to keep the power low, but large enough to allow the V_{maxCell} feedback to keep V_{maxCell} below V_{maxCell,des}.

$$\begin{matrix}Algorithm 1 : Current = {I}_{nom} ( P max , Vstack ) + {k}_{p 1} * ( {V}_{maxCell} - {V}_{maxCell , des} ) \\ Algorithm 2 : {θ}_{valve} = {k}_{p 2} * ( {V}_{stack , des} - {V}_{stack} )\end{matrix}$$

Fuel cell single cell terminal voltage (V_{cell}) is open circuit voltage (OCV) subtracted by ohmic loss, activation loss, and concentration loss. These losses involve complicated interactions of many variables, including but not limited to, stack current, membrane humidity level, cathode pressure, O2 concentration, coolant temperature, and/or age of fuel cell stack 202. The OCV may be sensitive to reacting species (O2) in the cathode during desired operating parameters of the power conservation mode where reacting species is starved. The losses are the most sensitive and responsive to stack current. For the desired operating parameters of the power conservation mode, the stack voltage is suppressed to reduce power of the fuel cell stack 202, and the overall stack voltage is dependent on how much p_{O2} is on the cathode of the cells.

In one form, the SCVS control 132 is configured to operate the compressor 222 at a constant speed setpoint, and the cathode valves 260, 262, 264 are controlled to restrict mass air flow (MAF). The CBV inlet (e.g., valve 260), CBV outlet (e.g., valve 262), and HOV valve (e.g., valve 264) are arranged sequentially, and the smallest opening is the dominating one in restricting the air flow. By controlling the cathode valves 260, 262, 264 to control air flow, the SCVS control 132 is configured to control the stack voltage through p_{O2}, which has relatively slow dynamics due to the manifold filling dynamics.

The exhaust H2-conc control 134 is configured to monitor and control level of H2 concentration in the exhaust line 249. That is, any residual hydrogen in the hydrogen SRS 204 is expelled through the exhaust line 249 increasing hydrogen concentration. In a non-limiting example, a H2 concentration threshold level is selected based on a standard issued by a government agency, such as but not limited to a hydrogen concentration being less than or equal to 4% when measured 100 mm away from the exhaust line 249 at a centerline of the exhaust line 249 in a 3 sec moving average window. The sensors 105 of the FCS 102 may include devices to measure the amount of H2 being provided to the exhaust line 249.

In one form, to control the amount of H2 concentration, the exhaust H2-conc control 134 supplies air through a bypass flow path that bypasses the stack 202 to dilute the H2 concentration in the exhaust line 249 (FIG. 2). For example, with the bypass 268 open, air from the intercooler 224 flows to the exhaust line 249 diluting the fluid flowing therein.

The FCR control 136 is configured to periodically refresh the FCS 102 by intermittently exiting the power conservation mode. In one form, the FCR control 136 detects that the FCS 102 is in a prolonged idle operation when, at least one of the following is provided: a duration of power suppression is greater than or equal to a prolonged conservation threshold (e.g., 30 mins); a temperature of a fuel stack coolant is less than or equal to a coolant operating threshold; amount of water in the FCS 102 being equal to or greater than a water threshold; and/or oxygen (O2) level in a fuel cell is less than or equal to a cumulative fuel threshold. The FCR control 136 my perform the refresh for a selected time period (e.g., 5-mins) and/or if one or more thresholds are met (e.g., temperature of fuel stack coolant greater than coolant operating threshold, water level less than a water threshold, and/or oxygen level is greater than cumulative fuel threshold.)

When the FCEV 100 is in the power conservation mode (e.g., an idle state) for a period of time, water may accumulate in the fuel cell stack 202. The water can block membrane pores and prevent reactants from reaching the catalyst, potentially causing unstable operation. By exiting the power conservation mode, the FCR control 136 can draw more current to generate heat and increase mass air flow to remove water from the fuel cell stack 202. Accordingly, in one form, the FCR control 136 is configured to monitor how long the FCEV 100 is in the power conservation mode (e.g., idle state), and if it is greater than or equal to an idle time threshold (e.g., 30 minutes), the FCR control 136 operates the FCS 102 to generate a chemical reaction in the fuel cell stack 202 to refresh the fuel cell stack.

In some variations, the FCR control 136 determines if temperature of the coolant returning to the thermal system 119 is less than or equal to a coolant temperature threshold. If so, the FCR control 136 refreshes the fuel cell stack 202 (e.g., supplies reactants (e.g., H2 and/or air) to the fuel cell stack 202). In another example, the FCR control determines if whether the amount of oxygen in the fuel cell stack 202 is low by detecting when the voltage of fuel cell stack 202 is less than or equal to a voltage threshold. If minimum cell voltage drops too low, the FCR control 136 determines the cells are starved of reactants (e.g., O2) and may be replenished by exiting the power conservation mode and supplying air to the fuel cell stack 202.

In some aspects, the FCR control 136 is configured to detect whether the amount of water is equal to or greater than the water threshold, and if so, reduce amount of liquid water accumulation in the fuel cell stack 202. In a non-limiting example, water may be reduced by diverting air flow from the compressor 222 around the humidifier 226 with the valve 228 and/or increasing temperature of the fuel cell stack 202 by reducing coolant flow or increasing temperature of the coolant by circulating the coolant through an electric heater provided with the thermal system 119 prior to providing the coolant to the fuel cell stack 202. In one form, cell flooding can be detected if cell voltages oscillate aggressively through an injector pulse.

In one form, the PCM 122 may exit the power conservation mode in various suitable ways, such as but not limited to: the acceleration pedal being pressed; a power request being equal to a or greater than a selected power threshold (e.g., selected based on nominal amount of power needed to operate the EM 114); or the FCEV 100 being turned off.

While the PCM 122 includes controls 130, 132, 134, and 136, the PCM 122 may include one or more of the controls and is not limited to including each of the controls 130, 132, 134, and 136.

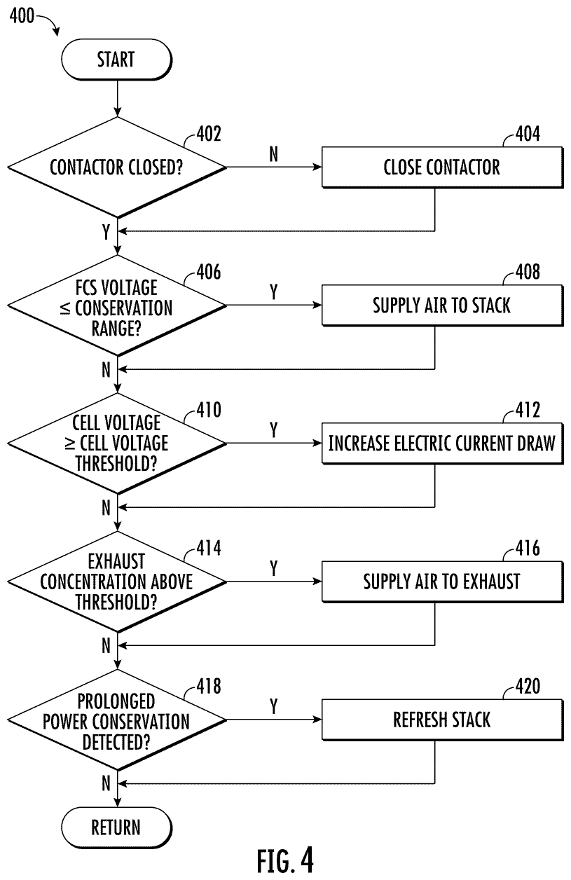

Referring to FIG. 4, an example power conservation routine 400 is provided and performed by the control system 118 when the power conservation mode is entered. In a non-limiting example, the control system 118 controls the fuel cell system in the power conservation mode in response to at least one of a power request being less than or equal to a power conservation threshold or the SOC of the battery pack 104 being greater than or equal to the SOC threshold.

At operation 402, the system 118 determines if the contactor 117 is closed. If it is not closed, the system 118 closes the contactor to electrically couple the FCS 102 to the powertrain system 112 via the PEM 116, at operation 404. In a non-limiting example, the control system 118 may transmit control signals to a power switch (not shown) associated with the contactor 117 to close the contactor 117.

At operation 406, the system 118 determine if a voltage of the FCS is within a voltage conservation range, as described above in association with the SCVS control 132. In a non-limiting example, the control system 118 determines if a cell voltage of the stack voltage is less than or equal to a respective FCS voltage threshold.

At operation 408, if the voltage of the FCS 102 is outside the conservation range, and specifically is below the FCS voltage threshold, the system 118 selectively supplies air into the fuel cell stack 202 to control the voltage of the FCS 102. For example, the system 118 provides a control signal to one or more of the cathode valves 260, 262, 264 to at least partially open at least one of the cathode valves 260, 262, 264.

At operation 410, the system 118 determines if the cell voltage is greater than or equal to a cell voltage threshold (e.g., a maximum cell voltage threshold). If so, the system 118 draws additional current from the fuel cell stack 202.

At operation 414, the system 118 determines if the exhaust concentration (e.g., H2 concentration) is above a threshold, as detailed above. If so, the system 118 selectively supplies air to the exhaust line 249 to dilute concentration of the fluid flowing therein, at operation 416.

At operation 418, the system 118 detects a prolonged operation in the power conservation mode. For example, the prolonged operation in the power conservation mode is indicative of at least one of: a temperature of a coolant for the FCS 102 being less than or equal to a temperature threshold, an amount of O2 in the fuel cell stack 202 being less than or equal to a reactant threshold, the amount of liquid water in the fuel cell stack 202 being greater than or equal to a water threshold, or the FCS 102 is controlled in the power conservation mode for a time period that is greater than or equal to a prolonged conservation threshold.

If the system 118 detects prolonged operation in the power conservation mode, the system 118 performs a refresh operation of the fuel cell stack 202, at operation 420. In a non-limiting example, for the refresh operation, more current is drawn, the temperature of the coolant for the thermal system may be increased to increate temperature of the fuel cell stack 202, and/or air drawn by the compressor 222 bypasses the humidifier 226 to limit the amount of water being introduced to the fuel cell stack 202.

After operation 418 or 420, the system 118 repeats the routine 400 until, for example, the power conservation mode is to be exited to enter a normal drive control or the FCEV 100 is to be turned off.

The routine 400 is just one example of the power conservation mode and may be defined in various suitable ways. For example, the routine 400 may not include all of the operation provided.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code (e.g., programming instructions); a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlling a fuel cell electric vehicle (FCEV) having a fuel cell system, comprising:
restricting, for a power conservation mode, electric current draw of a fuel cell stack of the fuel cell system; and
performing, for the power conservation mode, at least one of:
selectively supplying air to the fuel cell system to control a voltage of the fuel cell system, or
selectively supplying air to an exhaust flow line to dilute concentration of fluid flowing therein.

2. The method of claim 1, further comprising closing a contactor to electrically couple the fuel cell system to a load using in response to the FCEV being turned-on, wherein the fuel cell system remains electrically coupled to the fuel cell system for the power conservation mode.

3. The method of claim 1, further comprising drawing additional current from the fuel cell system to generate electrical power and exit the power conservation mode in response to a power request being equal to or greater than a selected power threshold.

4. The method of claim 1, further comprising, for the power conservation mode, generating electrical power in response to detecting prolonged operation in the power conservation mode.

5. The method of claim 4, wherein the prolonged operation in the power conservation mode is detected based on at least one of:
a temperature of a coolant for the fuel cell system being less than or equal to a temperature threshold,
an amount of oxygen in the fuel cell stack being less than or equal to a threshold,
an amount of liquid water in the fuel cell stack being greater than or equal to a water threshold, or
the fuel cell system being controlled in the power conservation mode for a time period that is greater than or equal to a prolonged conservation threshold.

6. The method of claim 1, wherein the air is supplied to the fuel cell system to control the voltage of the fuel cell system in response to a fuel cell voltage being less than or equal to a fuel cell system voltage threshold.

7. The method of claim 1, further comprises, for the power conservation mode, draw electric current from the fuel cell stack in response to a fuel cell voltage being greater than or equal to a max cell voltage threshold.

8. The method of claim 1, wherein to selectively supply air to the fuel cell system to control the voltage of the fuel cell system, the method further includes at least partially opening at least one cathode valve from among a plurality of cathode valves provided along an air-cathode fluid line for supplying the air to a cathode side of the fuel cell stack based on at least one of a voltage of the fuel cell stack or a voltage of one or more fuel cells from among a plurality of fuel cells forming the fuel cell stack.

9. The method of claim 1, further comprising controlling the fuel cell system in the power conservation mode in response to at least one of a power request being less than or equal to a power conservation threshold or a state of charge (SOC) of a battery pack being greater than or equal to a SOC threshold.

10. A control system for a fuel cell electric vehicle (FCEV) having a fuel cell system, comprising:
a processor; and
a non-transitory computer-readable storage medium comprising programming instructions that are configured to cause the processor to implement a method for controlling the FCEV, wherein the programming instructions comprise instructions to:
restrict, for a power conservation mode of the fuel cell system, electric current draw from a fuel cell stack of the fuel cell system; and
perform, for the power conservation mode, at least one of:
selectively supply air to the fuel cell system to control a voltage of the fuel cell system, or
selectively supply air to an exhaust flow line of the FCEV to dilute concentration of fluid flowing therein.

11. The control system of claim 10, wherein the programming instructions further include instructions to close a contactor to electrically couple the fuel cell system to a load in response to the FCEV being turned-on, wherein the fuel cell system remains electrically coupled to the fuel cell system for the power conservation mode.

12. The control system of claim 10, wherein the programming instructions further include instructions to draw current from the fuel cell system to generate electrical power and exit the power conservation mode in response to a power request being equal to or greater than a selected power threshold.

13. The control system of claim 10, wherein the programming instructions further include instructions to, for the power conservation mode, generating electrical power in response to detecting prolonged operation in the power conservation mode.

14. The control system of claim 13, wherein the prolonged operation in the power conservation mode is indicative of at least one of:
a temperature of a coolant for the fuel cell system being less than or equal to a temperature threshold,
an amount of liquid water in the fuel cell stack being greater than or equal to a threshold,
an amount of oxygen in the fuel cell stack being less than or equal to a threshold, or
the fuel cell system being controlled in the power conservation mode for a time period that is greater than or equal to a prolonged conservation threshold.

15. The control system of claim 10, wherein the air is supplied to the fuel cell system to control the voltage of the fuel cell system in response to a fuel cell voltage being less than or equal to a fuel cell system voltage threshold.

16. The control system of claim 10, wherein the programming instructions further include instructions to, for the power conservation mode, draw electric current from the fuel cell stack in response to a fuel cell voltage being greater than or equal to a max cell voltage threshold.

17. The control system of claim 10, wherein to selectively supply air to the fuel cell system to control the voltage of the fuel cell system, the programming instructions further include instructions to, at least partially open at least one cathode valve from among a plurality of cathode valves provided along an air-cathode fluid line for supplying the air to a cathode side of the fuel cell stack based on at least one of a voltage of the fuel cell stack or a voltage of one or more fuel cells from among a plurality of fuel cells forming the fuel cell stack.

18. The control system of claim 10, wherein the programming instructions further include instructions to control the fuel cell system in the power conservation mode in response to at least one of a power request being less than or equal to a power conservation threshold or a state of charge (SOC) of a battery pack being greater than or equal to a SOC threshold.

19. A fuel cell electric vehicle, comprising:
a fuel cell system including a fuel cell system; and
one or more controllers configured to:
restrict, for a power conservation mode of the fuel cell system, current draw of a fuel cell stack of the fuel cell system, and
perform, for the power conservation mode, at least one of:
selectively supply air to the fuel cell system to control a voltage of the fuel cell system, or
selectively supply air to an exhaust flow line to dilute concentration of fluid flowing therein.

20. The vehicle of claim 19, wherein the one or more controllers are further configured to generate electrical power in response to detecting prolonged operation in the power conservation mode, wherein the prolonged operation in the power conservation mode is indicative of at least one of:
a temperature of a coolant for the fuel cell system being less than or equal to a temperature threshold,
an amount of liquid water in the fuel cell stack being greater than or equal to a threshold,
an amount of O2 in the fuel cell stack being less than or equal to a reactant threshold, or
the fuel cell system being controlled in the power conservation mode for a time period that is greater than or equal to a prolonged conservation threshold.
